(19) United States
(12) Patent Application Publication
(10) Pub. No.: US 2017/0229031 A1
(43) Pub. Date: Aug. 10, 2017

(54) METHOD AND SYSTEM FOR RECORDING WEBPAGE READING PROCESS BASED ON PIECEWISE INTERACTIVE MODE

(71) Applicant: SHANGHAI NETBAN EDUCATION TECHNOLOGY COMPANY LIMITED, Shanghai (CN)

(72) Inventor: JIANBIAO DAI, Shanghai (CN)

(73) Assignee: SHANGHAI NETBAN EDUCATION TECHNOLOGY COMPANY LIMITED

(21) Appl. No.: 15/130,478

(22) Filed: Apr. 15, 2016

(30) Foreign Application Priority Data
Feb. 5, 2016 (CN) 2016-10081840.4

(51) Int. Cl. G09B 5/06; H04L 29/06; H04L 29/08; G06F 17/22

(52) U.S. Cl. CPC G09B 5/065; G06F 17/2247; H04L 67/42; H04L 67/10; H04L 67/02

(57) ABSTRACT

In a method and a system for recording a webpage reading process based on a piecewise interactive mode provided by the present invention, wherein a student logs in a client, obtains learning contents from a server and displays the learning contents in a browser, when the student learns related learning contents, the student is likely to operate the browser, and the browser will obtain the browser operation condition of the student from the client in real time, so that the learning condition of the student can be obtained. Moreover, corresponding information will be returned to the browser in real time according to the browser operation condition of the student. Specified learning contents are sent to the student according to the browser operation condition of the student. The method has the advantages of being simple, direct and convenient, thereby having a wide application prospect.

### CROSS-REFERENCES TO RELATED APPLICATIONS

This application claims the priority of Chinese Patent Application No. 201610081840.4, filed on Feb. 5, 2016, the entire contents of which is incorporated herein by reference.

### FIELD OF THE DISCLOSURE

The present invention relates to a method and a system for recording a webpage reading process based on a piecewise interactive mode, and belongs to the field of education.

### BACKGROUND

Along with the large-scale application of networks, especially the mobile internet, online education has been developed rapidly. In reality, a student usually accesses a server through a browser to accept online education service. This is just a one-way service, namely, the server provides learning contents, and the student accepts the learning contents in a one-way manner; while the server cannot obtain the learning condition (for example, the student does not view the learning content or do other things when learning) of the student, and thus cannot master the learning effect of the student. Therefore, an online education method and system based on the Internet and capable of obtaining the learning condition of the student is urgently needed.

### BRIEF SUMMARY OF THE DISCLOSURE

To solve the above technical problems, the present invention provides a method for recording a webpage reading process based on a piecewise interactive mode. In the method, a student logs in a client and obtains learning contents from a server and displays the learning contents in a browser, when the student learns related learning contents, the student is likely to operate the browser, and the browser will obtain the browser operation condition of the student from the client in real time, so that the learning condition of the student can be obtained. Moreover, corresponding information will be returned to the browser in real time according to the browser operation condition of the student. Specified learning contents are sent to the student according to the browser operation condition of the student. The method has the advantages of being simple, direct and convenient, thereby having a wide application prospect.

To achieve the above purpose, the technical solutions of the present invention are as follows.

One aspect of the present disclosure provides a method for recording a webpage reading process based on a piecewise interactive mode, including the following steps: a client obtains a first paragraph of learning contents from a server and displays the first paragraph of learning contents on a browser; the server monitors the client within a first learning time period; the server obtains browser operation information of a student from the client and returns corresponding information to the browser; and when the client is about to obtain a second paragraph of learning contents from the server, the server sends specified learning contents to the client according to the browser operation information of the student.

Preferably, the browser operation information of the student includes a starting time and an ending time when the student tows a bottom brace, an up and down sliding distance of a Web page and a height of the Web page; and the server sends the specified learning contents to the client according to the browser operation information of the student in the following specific manner: when detecting that the difference between the ending time and the starting time when the student tows a bottom brace is smaller than a preset time and the up and down sliding distance of the Web page is larger than the height of the Web page, the server sends the first paragraph of learning contents to the client, or otherwise, the server sends the second paragraph of learning contents.

Preferably, the browser operation information of the student includes operation information of the student on a learning video and audio play area; and the server sends the specified learning contents to the client according to the browser operation information of the student in the following specific manner: when detecting that the student carries out a fast forward operation on the learning video and audio play area, the server sends the first paragraph of learning contents to the client, or otherwise, the server sends the second paragraph of learning contents.

Preferably, the browser operation information of the student includes a time when the browser starts to display the first paragraph of learning contents and a time when the student closes the browser. The server sends the specified learning contents to the client according to the browser operation information of the student in the following specific manner: when detecting that the time difference between the time when the student closes the browser and the time when the browser starts to display the first paragraph of learning contents is smaller than a preset time, the server sends the first paragraph of learning contents to the client, or otherwise, the server sends the second paragraph of learning contents.

Preferably, the server obtains the browser operation information of the student from the client and returns the corresponding information to the browser in the following specific manner: the server obtains learning process information of the student from the client, and when detecting that the student has learnt a certain knowledge point, the server sends a test of the knowledge point to the browser; and the server checks an answer of the test from the client, and sends the test of the knowledge point to the browser again when the answer conforms to preset requirements.

Another aspect of the present disclosure provides a system for recording a webpage reading process based on a piecewise interactive mode, including a plurality of clients and a server. The client includes a browser and a monitoring module; the server includes a processor system and a learning content database connected to the processor system; and the browser and the monitoring module are connected to the processor system. The learning content database is used for storing all the learning contents of a course, the browser is used for obtaining related web pages containing the learning contents from the processor system and displaying the web pages to a student, and the monitoring module is used for monitoring the client and sending browser operation information of the student to the processor system. The processor system is used for executing the following functions: when the browser obtains a first paragraph of learning contents from the processor system, the processor system feeds back a web page containing the first paragraph of learning contents to the browser; within a first period of learning time, the monitoring module monitors the client, obtains the browser operation information of the student and sends the browser operation information of the student to the processor system; and the processor system receives the browser operation information of the student and returns corresponding information to the browser; and when the browser is about to obtain a second paragraph of learning contents from the processor system, the processor system sends specified learning contents to the browser according to the browser operation information of the student.

Preferably, the browser operation information of the student includes a starting time and an ending time when the student tows a bottom brace, an up and down sliding distance of a Web page and a height of the Web page; and the processor system sends the specified learning contents to the browser according to the browser operation information of the student in the following specific manner: when detecting that the difference between the ending time and the starting time when the student tows a bottom brace is smaller than a preset time and the up and down sliding distance of the Web page is larger than the height of the Web page, the processor system sends a web page containing the first paragraph of learning contents to the browser, or otherwise, the processor system sends a web page containing the second paragraph of learning contents.

Preferably, the browser operation information of the student includes operation information of the student on a learning video and audio play area; and the processor system sends the specified learning contents to the browser according to the browser operation information of the student in the following specific manner: when detecting that the student carries out a fast forward operation on the learning video and audio play area, the processor system sends a web page containing the first paragraph of learning contents to the browser, or otherwise, the processor system sends a web page containing the second paragraph of learning contents.

Preferably, the browser operation information of the student includes a time when the browser starts to display the first paragraph of learning contents and a time when the student closes the browser. The processor system sends the specified learning contents to the browser according to the browser operation information of the student in the following specific manner: when detecting that the time difference between the time when the student closes the browser and the time when the browser starts to display the first paragraph of learning contents is smaller than a preset time, the processor system sends a web page containing the first paragraph of learning contents to the browser, or otherwise, the processor system sends a web page containing the second paragraph of learning contents.

Preferably, the server further includes a test database connected to the processor system, a test corresponding to each knowledge point is stored in the test database, and the processor system receives the browser operation information of the student and returns corresponding information to the browser in the following specific manner: the processor system obtains learning process information of the student from the monitoring module, and when detecting that the student has learnt a certain knowledge point, the processor system obtains the test corresponding to the knowledge point from the test database and sends the test to the browser; and the server checks an answer of the test from the client, and sends the test of the knowledge point to the browser again when the answer conforms to preset requirements.

The present invention has the following beneficial effects.

(1) In the method and the system for recording the webpage reading process based on the piecewise interactive mode provided by the present invention, wherein the student logs in the client and obtains the learning contents from the server and displays the learning contents in the browser, when the student learns related learning contents, the student is likely to operate the browser, and the browser will obtain the browser operation condition of the student from the client in real time, so that the learning condition of the student can be obtained. Moreover, corresponding information will be returned to the browser in real time according to the browser operation condition of the student. Specified learning contents are sent to the student according to the browser operation condition of the student. The method has the advantages of being simple, direct and convenient, thereby having a wide application prospect.

(2) By adopting the method and the system for recording the webpage reading process based on the piecewise interactive mode provided by the present invention, up and down sliding of the bottom brace, fast forward of videos and audios, closure of the browser in advance, view of other contents besides the browser and the like carried out by the student can be detected, so as to prevent the student from skipping some learning contents.

### BRIEF DESCRIPTION OF THE DRAWINGS

FIG. 1 is a flowchart of a method for recording a webpage reading process based on a piecewise interactive mode provided by the present invention; and

FIG. 2 is an architecture diagram of a system for recording a webpage reading process based on a piecewise interactive mode provided by the present invention.

Reference numbers in the drawings: 1 represents a client, 11 represents a browser, 12 represents a monitoring module, 2 represents a server, 21 represents a processor system, and 22 represents a learning content database.

### DETAILED DESCRIPTION

The present invention will be further illustrated below in detail in combination with embodiments.

### Embodiment 1

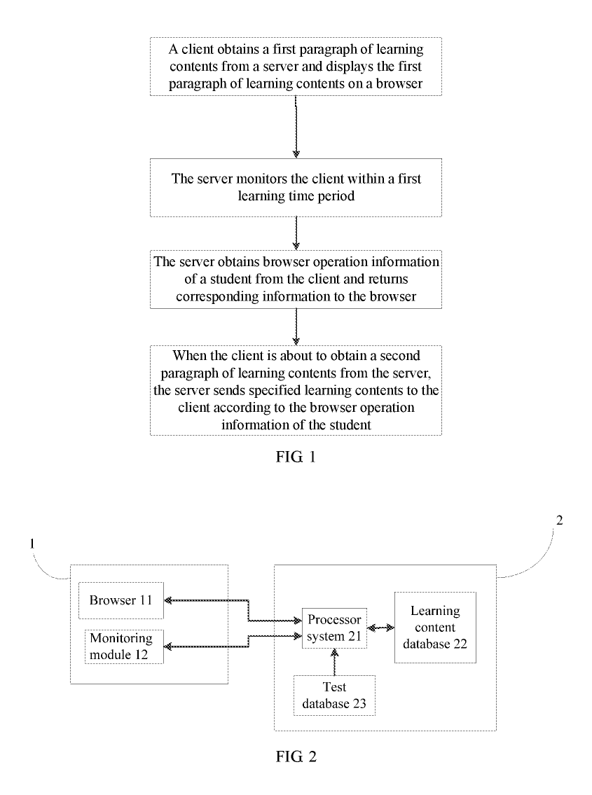

The present invention provides a method for recording a webpage reading process based on a piecewise interactive mode. As shown in FIG. 1, the method includes the following steps: a client obtains a first paragraph of learning contents from a server and displays the first paragraph of learning contents on a browser; the server monitors the client within a first learning time period; the server obtains browser operation information of a student from the client and returns corresponding information to the browser; and when the client is about to obtain a second paragraph of learning contents from the server, the server sends specified learning contents to the client according to the browser operation information of the student.

All the learning contents are stored in the server, and the student needs to log in the client, open a browser connection and log in the server to obtain the learning contents. The learning contents can include characters, videos, audios, etc.

In a real online learning system, knowledge points are usually compiled in paragraphs, when the student has learnt the first paragraph of learning contents, the student will learn the second paragraph of learning contents, and so on, until all the knowledge points of a course are learnt. Moreover, the time of student for learning the first paragraph of learning contents is a first learning time period.

As an implementation method, a monitoring module can be installed at the client, the monitoring module can monitor the browser operation information of the student in real time and send the browser operation information to the server. The implementation form of the module can be software, hardware or a combination of software and hardware.

Optionally, the server obtains and stores the browser operation information of the student from the client.

According to the method for recording the webpage reading process based on the piecewise interactive mode provided by the present invention, in the method, the student logs in the client and obtains the learning contents from the server and displays the learning contents in the browser, when the student learns related learning contents, the student is likely to operate the browser, and the browser will obtain the browser operation condition of the student from the client in real time, so that the learning condition of the student can be obtained. Moreover, corresponding information will be returned to the browser in real time according to the browser operation condition of the student. Specified learning contents are sent to the student according to the browser operation condition of the student. The method has the advantages of being simple, direct and convenient, thereby having a wide application prospect.

Preferably, the browser operation information of the student includes a starting time and an ending time when the student tows a bottom brace, an up and down sliding distance of a Web page and a height of the Web page; and the server sends the specified learning contents to the client according to the browser operation information of the student in the following specific manner: when detecting that the difference between the ending time and the starting time when the student tows a bottom brace is smaller than a preset time and the up and down sliding distance of the Web page is larger than the height of the Web page, the server sends the first paragraph of learning contents to the client, or otherwise, the server sends the second paragraph of learning contents.

When the student is learning, and particularly when the learning contents are web pages and pictures, the student may tow the bottom brace to skip a certain paragraph of learning contents. Therefore, when the student skips a certain paragraph of learning contents in the first paragraph of learning contents, the student can be forced to continue to learn the first paragraph of learning contents.

Preferably, the browser operation information of the student includes operation information of the student on a learning video and audio play area; and the server sends the specified learning contents to the client according to the browser operation information of the student in the following specific manner: when detecting that the student carries out a fast forward operation on the learning video and audio play area, the server sends the first paragraph of learning contents to the client, or otherwise, the server sends the second paragraph of learning contents.

When the student is learning, and particularly when the learning contents are videos and audios, the student may carry out a fast forward operation to skip a certain paragraph of learning contents. Therefore, when the student skips a certain paragraph of learning contents in the first paragraph of learning contents, the student can be forced to continue to learn the first paragraph of learning contents.

Preferably, the browser operation information of the student includes a time when the browser starts to display the first paragraph of learning contents and a time when the student closes the browser. The server sends the specified learning contents to the client according to the browser operation information of the student in the following specific manner: when detecting that the time difference between the time when the student closes the browser and the time when the browser starts to display the first paragraph of learning contents is smaller than a preset time, the server sends the first paragraph of learning contents to the client, or otherwise, the server sends the second paragraph of learning contents.

For each paragraph of learning contents, the time of the student for learning the paragraph of learning contents can be predicted, when the time of the student for learning the paragraph of learning contents is smaller than a preset value (the preset value can be a time of most students for learning the paragraph of learning contents at a highest learning speed), it can be deemed that the student skips some knowledge points in the paragraph of learning contents. Therefore, when the student skips a certain paragraph of learning contents in the first paragraph of learning contents, the student can be forced to continue to learn the first paragraph of learning contents.

Preferably, the server obtains the browser operation information of the student from the client and returns corresponding information to the browser in the following specific manner: the server obtains browser window size information from the client, and when detecting that the browser widow is not in full-screen display, the server sends information indicating the student to display the browser in full screen to the browser.

When the student is learning, and when the student is viewing the learning contents on the browser, if the browser is not displayed in full screen, other contents may be displayed on other places of the screen, therefore the attention of the student may be diverted, and thus it is necessary to remind the student to set the browser to be in a full-screen display mode.

Preferably, the server obtains the browser operation information of the student from the client and returns the corresponding information to the browser in the following specific manner: the server obtains learning process information of the student from the client, and when detecting that the student has learnt a certain knowledge point, the server sends a test of the knowledge point to the browser; and the server checks an answer of the test from the client, and sends the test of the knowledge point to the browser again when the answer conforms to preset requirements.

As an implementation method, when the learning contents are videos and audios, whether the student has learnt a certain knowledge point can be judged according to the play progress of the videos and audios; and when the learning contents are characters, a button can be set, when the student clicks the button, it can be deemed that the student has learnt the knowledge point.

After the student has learnt a certain knowledge point, the test of the knowledge point will be sent to the student, meanwhile the answer will be checked, and if the answer does not conform to the preset requirements, the test will be sent again.

Optionally, a button can be arranged on the web page, and when the student clicks the web page, it indicates that the student has learnt a certain knowledge point or a certain paragraph of learning contents.

### Embodiment 2

The present invention provides a system for recording a webpage reading process based on a piecewise interactive mode. As shown in FIG. 2, the system includes a plurality of clients 1 and a server 2.

The client 1 includes a browser 11 and a monitoring module 12; the server 2 includes a processor system 21 and a learning content database 22 connected to the processor system; and the browser 11 and the monitoring module 12 are connected to the processor system 21.

The learning content database 22 is used for storing all the learning contents of a course, the browser 11 is used for obtaining related web pages containing the learning contents from the processor system 21 and displaying the web pages to a student, and the monitoring module 12 is used for monitoring the client 1 and sending browser operation information of the student to the processor system 21.

The processor system 21 is used for executing the following functions.

When the browser 11 obtains a first paragraph of learning contents from the processor system 21, the processor system 21 feeds back a web page containing the first paragraph of learning contents to the browser 11.

Within a first period of learning time, the monitoring module 12 monitors the client, obtains the browser operation information of the student and sends the browser operation information of the student to the processor system 21; and the processor system 21 receives the browser operation information of the student and returns corresponding information to the browser 11.

When the browser 11 is about to obtain a second paragraph of learning contents from the processor system 21, the processor system 21 sends specified learning contents to the browser 11 according to the browser operation information of the student.

Preferably, the browser operation information of the student includes a starting time and an ending time when the student tows a bottom brace, an up and down sliding distance of a Web page and a height of the Web page; and the processor system 21 sends the specified learning contents to the browser 11 according to the browser operation information of the student in the following specific manner: when detecting that the difference between the ending time and the starting time when the student tows a bottom brace is smaller than a preset time and the up and down sliding distance of the Web page is larger than the height of the Web page, the processor system 21 sends a web page containing the first paragraph of learning contents to the browser 11, or otherwise, the processor system sends a web page containing the second paragraph of learning contents.

Preferably, the browser operation information of the student includes operation information of the student on a learning video and audio play area; and the processor system 21 sends the specified learning contents to the browser 11 according to the browser operation information of the student in the following specific manner: when detecting that the student carries out a fast forward operation on the learning video and audio play area, the processor system 21 sends a web page containing the first paragraph of learning contents to the browser 11, or otherwise, the processor system sends a web page containing the second paragraph of learning contents.

Preferably, the browser operation information of the student includes a time when the browser starts to display the first paragraph of learning contents and a time when the student closes the browser. The processor system 21 sends the specified learning contents to the browser 11 according to the browser operation information of the student in the following specific manner: when detecting that the time difference between the time when the student closes the browser and the time when the browser starts to display the first paragraph of learning contents is smaller than a preset time, the processor system 21 sends a web page containing the first paragraph of learning contents to the browser 11, or otherwise, the processor system sends a web page containing the second paragraph of learning contents.

Preferably, the processor system 21 receives the browser operation information of the student and returns corresponding information to the browser 11 in the following specific manner: the processor system 21 obtains browser window size information from the monitoring module 12, and when detecting that the browser widow is not in full-screen display, the processor system 21 sends information indicating the student to display the browser in full screen to the browser.

Preferably, the server 2 further includes a test database 23 connected to the processor system 21, a test corresponding to each knowledge point is stored in the test database 23, and the processor system 21 receives the browser operation information of the student and returns corresponding information to the browser 11 in the following specific manner: the processor system 21 obtains learning process information of the student from the monitoring module 12, and when detecting that the student has learnt a certain knowledge point, the processor system 21 obtains the test corresponding to the knowledge point from the test database 23 and sends the test to the browser 11; and the server 2 checks an answer of the test from the client, and sends the test of the knowledge point to the browser 11 again when the answer conforms to preset requirements.

Optionally, the test is added by a teacher in the test database.

Optionally, a button can be set behind each knowledge point, and when the student clicks the button, it indicates that the student has learnt the knowledge point.

Obviously, the above embodiments are merely examples listed for clear illustration, but are not limitations to the embodiments. Those of ordinary skill in the art to which the present invention belongs can make other different forms of variations or modifications on the basis of the above illustration. There is no need and no way to exhaustively list all the embodiments. Apparent variations or modifications deduced herein are still encompassed within the protection scope of the present invention.

What is claimed is:

1. A method for recording a webpage reading process based on a piecewise interactive mode, comprising:
obtaining, by a client, a first paragraph of learning contents from a server and displaying, by the client, the first paragraph of the learning contents on a browser;
monitoring, by the server, the client within a first learning time period;
obtaining, by the server, a browser operation information of a student from the client and returning, by the server, corresponding information to the browser; and
when the client is about to obtain a second paragraph of the learning contents from the server, sending, by the server, specified learning contents to the client according to the browser operation information of the student.

2. The method of claim 1, wherein:
the browser operation information of the student comprises a starting time and an ending time when the student tows a bottom brace, an up and down sliding distance of a Web page and a height of the Web page; and
sending, by the server, specified learning contents to the client according to the browser operation information of the student further comprises: when detecting that a difference between the ending time and the starting time when the student tows a bottom brace is smaller than a preset time and the up and down sliding distance of the Web page is larger than the height of the Web page, sending, by the server, the first paragraph of the learning contents to the client, or otherwise, send, by the server, the second paragraph of the learning contents.

3. The method of claim 1, wherein:
the browser operation information of the student comprises operation information of the student on a learning video and audio play area; and
sending, by the server, specified learning contents to the client according to the browser operation information of the student further comprises: when detecting that the student carries out a fast forward operation on the learning video and audio play area, sending, by the server, the first paragraph of the learning contents to the client, or otherwise, sending, by the server, the second paragraph of the learning contents.

4. The method of claim 1, wherein:
the browser operation information of the student comprises a time when the browser starts to display the first paragraph of learning contents and a time when the student closes the browser; and
sending, by the server, specified learning contents to the client according to the browser operation information of the student further comprises: when detecting that a time difference between the time when the student closes the browser and the time when the browser starts to display the first paragraph of learning contents is smaller than a preset time, sending, by the server, the first paragraph of the learning contents to the client, or otherwise, sending, by the server, the second paragraph of the learning contents.

5. The method claim 1, wherein obtaining, by the server, a browser operation information of a student from the client and returning, by the server, corresponding information to the browser further comprises:
obtaining, by the server learning process information of the student from the client, and when detecting that the student has learnt a certain knowledge point, sending, by the server, a test of the knowledge point to the browser; and checking, by the server, an answer of the test from the client, and sending, by the server, the test of the knowledge point to the browser again when the answer conforms to preset requirements.

6. A system for recording a webpage reading process based on a piecewise interactive mode, comprising a plurality of clients and a server, wherein:
the client comprises a browser and a monitoring module; the server comprises a processor system and a learning content database connected to the processor system; and the browser and the monitoring module are connected to the processor system;
the learning content database is used for storing all the learning contents of a course, the browser is used for obtaining related web pages containing the learning contents from the processor system and displaying the web pages to a student, and the monitoring module is used for monitoring the client and sending browser operation information of the student to the processor system;
the processor system is used for executing the following functions:
when the browser obtains a first paragraph of learning contents from the processor system, the processor system feeds back a web page containing the first paragraph of learning contents to the browser;
within a first period of learning time, the monitoring module monitors the client, obtains the browser operation information of the student and sends the browser operation information of the student to the processor system; and the processor system receives the browser operation information of the student and returns corresponding information to the browser; and
when the browser is about to obtain a second paragraph of learning contents from the processor system, the processor system sends specified learning contents to the browser according to the browser operation information of the student.

7. The system of claim 6, wherein:
the browser operation information of the student comprises a starting time and an ending time when the student tows a bottom brace, an up and down sliding distance of a Web page and a height of the Web page; and
the processor system is further configured to: when detecting that a difference between the ending time and the starting time when the student tows a bottom brace is smaller than a preset time and the up and down sliding distance of the Web page is larger than the height of the Web page, send a web page containing the first paragraph of learning contents to the browser, or otherwise, send a web page containing the second paragraph of learning contents.

8. The system of claim 6, wherein:
the browser operation information of the student comprises operation information of the student on a learning video and audio play area; and
the processor system is further configured to: when detecting that the student carries out a fast forward operation on the learning video and audio play area, send a web page containing the first paragraph of learning contents to the browser, or otherwise, send a web page containing the second paragraph of learning contents.

9. The system of claim 6, wherein:
the browser operation information of the student comprises a time when the browser starts to display the first paragraph of learning contents and a time when the student closes the browser; and
the processor system is further configured to: when detecting that the time difference between the time when the student closes the browser and the time when the browser starts to display the first paragraph of learning contents is smaller than a preset time, send a web page containing the first paragraph of learning contents to the browser, or otherwise, send a web page containing the second paragraph of learning contents.

10. The system of claim 6, wherein:
the server further comprises a test database connected to the processor system, a test corresponding to each knowledge point is stored in the test database, and the processor system is further configured to: obtain learning process information of the student from the monitoring module , and when detecting that the student has learnt a certain knowledge point, obtain the test corresponding to the knowledge point from the test database and send the test to the browser; and check an answer of the test from the client, and send the test of the knowledge point to the browser again when the answer conforms to preset requirements.
